(19) United States
(12) Patent Application Publication
(10) Pub. No.: US 2025/0332611 A1
(43) Pub. Date: Oct. 30, 2025

(54) IRRADIATION DEVICE, RAY-EMITTING DEVICE, AND ULTRAVIOLET RAY IRRADIATION METHOD

(71) Applicant: Nichia Corporation, Anan-shi (JP)

(72) Inventors: Sara MINOMO, Anan-shi (JP); Yuichiro MURAKAMI, Tokushima-shi (JP); Tomotake TANAKA, Ota-ku (JP)

(21) Appl. No.: 19/187,700

(22) Filed: Apr. 23, 2025

(30) Foreign Application Priority Data
Apr. 26, 2024 (JP) 2024-073141
Mar. 14, 2025 (JP) 2025-041026

(51) Int. Cl. B05D 3/06

(52) U.S. Cl. CPC B05D 3/067

(57) ABSTRACT

An irradiation device configured to irradiate an object with ray is provided. The irradiation device includes a ray-emitting device including a first ray source and a second ray source that emit ultraviolet ray having different ray distributions, a placement table including an arrangement region in which the object is disposed for irradiation, and an irradiation controller that causes the object to be irradiated with the ultraviolet ray from the first ray source prior to the ultraviolet ray from the second ray source.

### CROSS-REFERENCE TO RELATED APPLICATION

This application claims priority to Japanese Patent Application No. 2024-073141, filed on Apr. 26, 2024, and Japanese Patent Application No. 2025-041026, filed on Mar. 14, 2025, the disclosure of which is hereby incorporated by reference in its entirety.

### TECHNICAL FIELD

The present disclosure relates to an irradiation device, a ray-emitting device, and an ultraviolet ray irradiation method.

### BACKGROUND

In the related art, there is disclosed a ray irradiation module including a plurality of ray irradiation devices each including a first ray-emitting element and a second ray-emitting element in order to reduce uneven curing of an object, in which the wavelength of ray of the second ray-emitting element is shorter than the wavelength of ray of the first ray-emitting element.

### SUMMARY

Embodiments of the present disclosure are directed to reducing uneven curing of an object.

An irradiation device according to an embodiment of the present disclosure is an irradiation device that irradiates an object with ray. The irradiation device includes a ray-emitting device including a first ray source configured to emit first ultraviolet ray and a second ray source configured to emit second ultraviolet ray having a ray distribution different from a ray distribution of the first ultraviolet ray emitted from the first ray source, a placement table comprising an arrangement region on which the object is disposed for irradiation, and an irradiation controller configured to cause the object to be irradiated with the first ultraviolet ray prior to the second ultraviolet ray.

A ray-emitting device according to an embodiment of the present disclosure is a ray-emitting device mounted in an irradiation device configured to irradiate an object with ray. The ray-emitting device includes a first ray source configured to emit first ultraviolet ray and a second ray source configured to emit second ultraviolet ray having a ray distribution different from a ray distribution of the first ultraviolet ray. In a region for irradiating the object, a non-overlapping region that is irradiated with one but not both of the first ultraviolet ray and the second ultraviolet ray is generated.

An ultraviolet ray irradiation method according to an embodiment of the present disclosure includes irradiating an object with first ultraviolet ray from a first ray source, the first ultraviolet ray having a first ray emission peak wavelength, irradiating the object with second ultraviolet ray from a second ray source, the second ultraviolet ray having the first ray emission peak wavelength and having a ray distribution different from a ray distribution of the first ultraviolet ray, irradiating the object with third ultraviolet ray from a third ray source, the third ultraviolet ray having a second ray emission peak wavelength shorter than the first ray emission peak wavelength, and irradiating the object with fourth ultraviolet ray from a fourth ray source, the fourth ultraviolet ray having the second ray emission peak wavelength and having a ray distribution different from a ray distribution of the third ultraviolet ray. Irradiating the object with the first ultraviolet ray and the second ultraviolet ray is performed prior to irradiating the object with the third ultraviolet ray and the fourth ultraviolet ray.

According to one or more embodiments of the present disclosure, uneven curing of an object can be reduced.

### BRIEF DESCRIPTION OF DRAWINGS

FIG. 1 schematically illustrates a side view of an irradiation device according to a first embodiment.

FIG. 2 schematically illustrates a cross-sectional view of an object in a state in which a first region of the object is irradiated with both of first ultraviolet ray having a first ray distribution angle from a first ray source and second ultraviolet ray having a second ray distribution angle from a second ray source.

FIG. 3 schematically illustrates a cross-sectional view of the object in a state in which a second region of the object is irradiated with the second ultraviolet ray but not substantially with the first ultraviolet ray.

FIG. 4 schematically illustrates a cross-sectional view of the object in a state in which a first surface of the object is irradiated with ray having a peak ray irradiance of the first ultraviolet ray from the first ray source.

FIG. 5 schematically illustrates a cross-sectional view of the object in a state in which a second surface of the object is irradiated with ray having a peak ray irradiance of the second ultraviolet ray from the second ray source.

FIG. 6 schematically illustrates a cross-sectional view of an example of the object.

FIG. 7 schematically illustrates a side view of an irradiation device according to a second embodiment.

FIG. 8 schematically illustrates a cross-sectional view of the object in a state in which the first region of the object is irradiated with both of third ultraviolet ray having a third ray distribution angle from a third ray source and fourth ultraviolet ray having a fourth ray distribution angle from a fourth ray source.

FIG. 9 schematically illustrates a cross-sectional view of the object in a state in which the second region of the object is irradiated with the fourth ultraviolet ray but not substantially with the third ultraviolet ray.

FIG. 10 schematically illustrates a cross-sectional view of the object in a state in which the first surface of the object is irradiated with ray having a peak ray irradiance of the third ultraviolet ray from the third ray source.

FIG. 11 schematically illustrates a cross-sectional view of the object in a state in which the second surface of the object is irradiated with ray having a peak ray irradiance of the fourth ultraviolet ray from the fourth ray source.

FIG. 12 schematically illustrates a side view of an irradiation device according to a third embodiment.

### DESCRIPTIONS

An irradiation device and an ultraviolet ray irradiation method according to embodiments of the present disclosure will be described in detail with reference to the drawings. The following embodiments exemplify the irradiation device and the ultraviolet ray irradiation method for embodying the technical concepts of the present embodiment, but the present disclosure is not limited to the following embodiments. The dimensions, materials, shapes, relative arrangements, and the like of the components described in the embodiments are not intended to limit the scope of the present disclosure, but are merely illustrative examples, unless otherwise specifically stated that they are limited to specific embodiments. The sizes, positional relationship, or the like of members illustrated in each of the drawings may be exaggerated for clarity of description. Further, in the following description, members having the same terms and reference characters represent the same or similar members, and a detailed description of these members will be omitted as appropriate.

In the following description, terms indicating a specific direction or position (for example, “upper,” “above,” “lower,” “below,” and other terms related to those terms) may be used. These terms are used only to make it easy to understand a relative relationship of positions, orientations, directions, and the like in the referenced drawings, and need not necessarily match the relationship at a time of use of the ray-emitting devices according to the embodiments. Also, these directions have no relation to the direction of gravity. In a term in the present specification, a depth direction may also be referred to as a thickness direction of the object.

### First Embodiment

<Configuration of Ultraviolet Ray Irradiation Device according to First Embodiment>

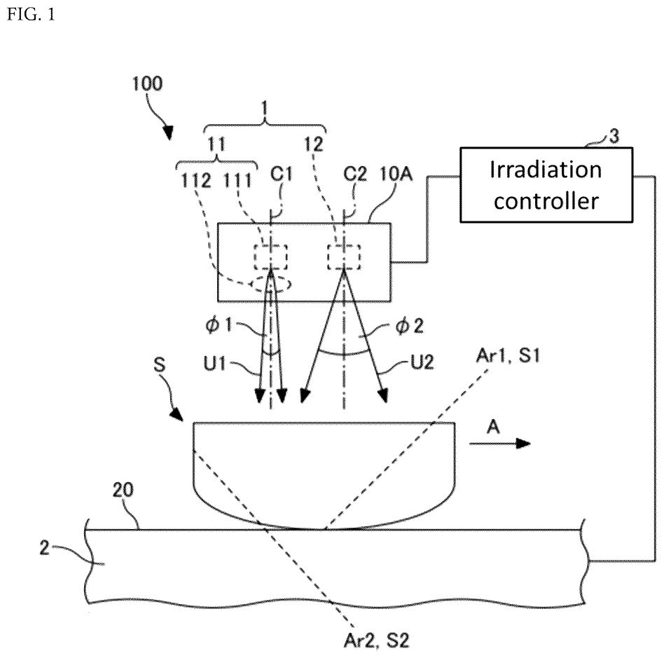

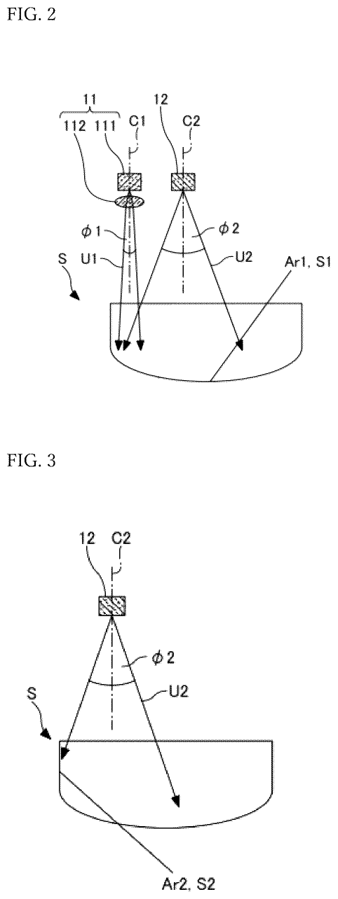

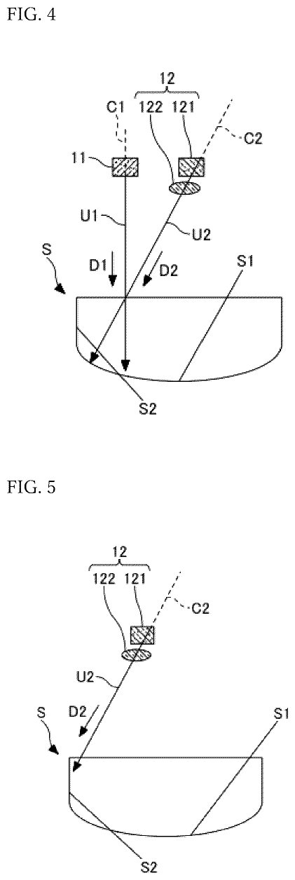

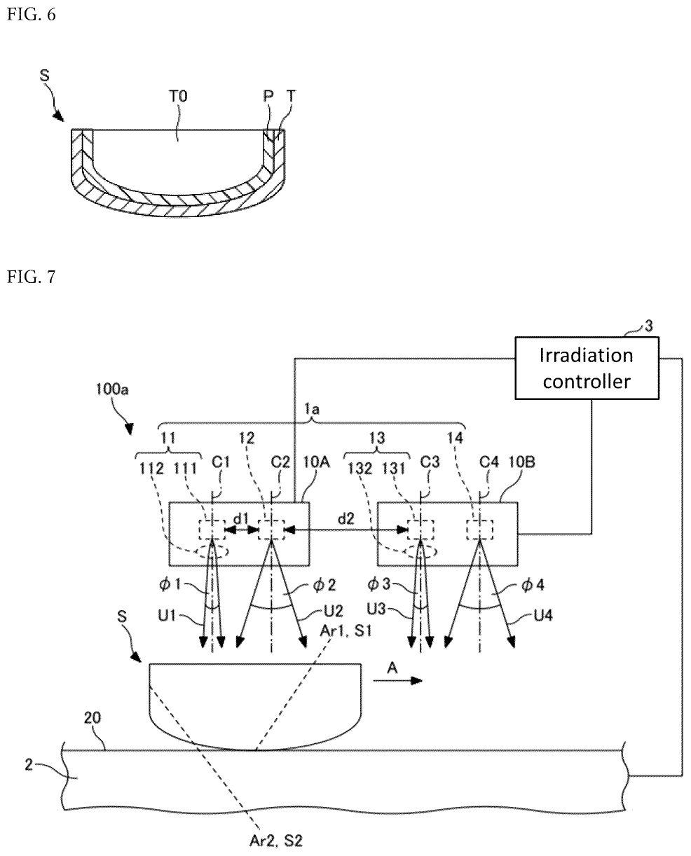

The configuration of an ultraviolet ray irradiation device according to a first embodiment will be described with reference to FIGS. 1 to 6. FIG. 1 schematically illustrates a side view of an irradiation device 100 according to the first embodiment. FIG. 2 schematically illustrates a cross-sectional view of an object S in a state in which a first region Ar1 of the object S is irradiated with both of a first ultraviolet ray U1 having a first ray distribution angle ϕ1 from a first ray source 11 and a second ultraviolet ray U2 having a second ray distribution angle ϕ2 from a second ray source 12. FIG. 3 schematically illustrates a cross-sectional view of the object S in a state in which a second region Ar2 of the object S is irradiated with the second ultraviolet ray U2 having the second ray distribution angle ϕ2 from the second ray source 12, but not substantially with the first ultraviolet ray U1. FIG. 4 schematically illustrates a cross-sectional view of the object S in a state in which a first surface S1 of the object S is irradiated with ray having a peak ray irradiance of the first ultraviolet ray U1 from the first ray source 11. FIG. 5 schematically illustrates a cross-sectional view of the object S in a state in which a second surface S2 of the object S is irradiated with ray having a peak ray irradiance of the second ultraviolet ray U2 from the second ray source 12. FIG. 6 schematically illustrates a cross-sectional view of an example of the object S.

In FIGS. 1 to 5, a part of each of the first ultraviolet ray U1 and the second ultraviolet ray U2 emitted from the irradiation device 100 is indicated by arrows. It is noted that the arrows indicating the first ultraviolet ray U1 and the second ultraviolet ray U2 mean that the irradiation device 100 can emit each of the first ultraviolet ray U1 and the second ultraviolet ray U2. Thus, the arrows indicating the first ultraviolet ray U1 and the second ultraviolet ray U2 do not mean that the irradiation device 100 is limitedly used for simultaneously emitting the first ultraviolet ray U1 and the second ultraviolet ray U2.

The irradiation device 100 is an irradiation device that irradiates the object S with ray, and includes a ray-emitting device 1 including a first ray source 11 that emits ultraviolet ray and a second ray source 12 that emits ultraviolet ray having a ray distribution different from a ray distribution of the ultraviolet ray emitted from the first ray source, a placement table 2 including an arrangement region 20 on which the object S is disposed so as to irradiate the object S with the ultraviolet ray, and an irradiation controller 3 for irradiating the object S with the ultraviolet ray from the first ray source 11 prior to the ultraviolet ray from the second ray source 12.

In the example illustrated in FIG. 1, the first ray source 11 and the second ray source 12 are disposed inside a housing 10A. Alternatively, the first ray source 11 and the second ray source 12 may be disposed on a surface of the housing 10A. The first ray source 11 irradiates the object S located below the housing 10A with the first ultraviolet ray U1. The second ray source 12 irradiates the object S located below the housing 10A with the second ultraviolet ray U2.

Here, in the irradiation device that irradiates the object S with ray, depending on the shape of the object S, a part of the object S may not be appropriately irradiated with the ultraviolet ray from the irradiation device and uneven curing may occur in the object S. For example, in FIG. 1, a case will be considered in which the object S having the first surface S1 intersecting a first optical axis C1 of the first ultraviolet ray U1 emitted from the first ray source 11 and the second surface S2 substantially parallel to the first optical axis C1 is irradiated with the first ultraviolet ray U1 from the irradiation device including only the first ray source 11. The first surface S1 intersects the first optical axis C1, and thus is preferably irradiated with the first ultraviolet ray U1 and appropriately cured. Meanwhile, the second surface S2 is substantially parallel to the first optical axis C1, and thus is less likely to be irradiated with the first ultraviolet ray U1 from the first ray source 11 and insufficiently cured. As a result, the appropriately cured first surface S1 and the insufficiently cured second surface S2 coexist in the object S, and thus uneven curing occurs in the object S.

The first optical axis C1 of the first ultraviolet ray U1 emitted from the first ray source 11 refers to an optical axis perpendicular to a ray-emitting surface of the first ray source 11 and passing through a point indicating a peak in a ray irradiance distribution of the first ray source 11. Hereinafter, the term “optical axis” is used with the same meaning.

The irradiation device 100 includes the first ray source 11 and the second ray source 12 that emit ultraviolet ray having mutually different ray distributions, and irradiates the object S with the ultraviolet ray from the first ray source 11 prior to the ultraviolet ray from the second ray source 12, which is achieved by the irradiation controller 3. Accordingly, the second surface S2 can be appropriately irradiated with the ultraviolet ray from at least one of the first ray source 11 and the second ray source 12 even when the object S includes the second surface S2 substantially parallel to the first optical axis C1. As a result, in the present embodiment, a region in which curing is insufficient can be reduced, and the uneven curing of the object S can be reduced.

The first ray source 11 emits the first ultraviolet ray U1 at the first ray distribution angle ϕ1. The second ray source 12 emits the second ultraviolet ray U2 at the second ray distribution angle ϕ2 larger than the first ray distribution angle ϕ1. The object S includes the first region Ar1 irradiated with both of the first ultraviolet ray U1 from the first ray source 11 and the second ultraviolet ray U2 from the second ray source 12, and the second region Ar2 irradiated with the second ultraviolet ray U2 from the second ray source 12 but not substantially with the first ultraviolet ray U1 from the first ray source 11.

In FIGS. 2 and 3, the first region Ar1 is a region facing the first ray source 11 and the second ray source 12 and including the first surface S1 intersecting each of the first optical axis C1 of the first ultraviolet ray U1 and the second optical axis C2 of the second ultraviolet ray U2. In FIG. 2, the reference characters of the first region Ar1 and the first surface S1 are illustrated together for the purpose of indicating that the first region Ar1 includes the first surface S1. Also in the following description, reference characters may be illustrated together for the same purpose. In FIG. 3, the second region Ar2 is a region including the second surface S2 substantially parallel to each of the first optical axis C1 of the first ultraviolet ray U1 and the second optical axis C2 of the second ultraviolet ray U2.

As illustrated in FIG. 2, the first region Ar1 is irradiated with both of the first ultraviolet ray U1 and the second ultraviolet ray U2. In contrast, as illustrated in FIG. 3, the second region Ar2 is irradiated with the first ultraviolet ray U1 having a small ray distribution angle at a significantly large incident angle. Thus, the second region Ar2 is irradiated with the first ultraviolet ray U1 for only a short time as compared with the second ultraviolet ray U2. That is, as illustrated in FIG. 3, the second region Ar2 is mainly irradiated with the second ultraviolet ray U2. Because the second region Ar2 is irradiated with the second ultraviolet ray U2, the second region Ar2 can be irradiated with sufficient ultraviolet ray for curing the object S even when the object S includes the second region Ar2. Accordingly, the uneven curing of the object S can be reduced. In addition, because the first region Ar1 is irradiated with both of the first ultraviolet ray U1 and the second ultraviolet ray U2, the object S can be cured in a shorter time than in a case in which the first region Ar1 is irradiated with the second ultraviolet ray U2 but not substantially with the first ultraviolet ray U1.

The first ray source 11 includes a first ray-emitting element 111 and a first lens 112 disposed between the first ray-emitting element 111 and the object S. The first lens 112 changes the ray distribution angle of ultraviolet ray emitted from the first ray-emitting element 111. The first lens 112 can make the first ray distribution angle ϕ1 of the first ultraviolet ray U1 emitted from the first ray source 11 different from the second ray distribution angle ϕ2 of the second ultraviolet ray U2 emitted from the second ray source 12. Accordingly, the object S can be irradiated with the ultraviolet rays having mutually different ray distributions. Further, for example, the first lens 112 reduces the ray distribution angle of the ultraviolet ray emitted from first ray-emitting element 111. Accordingly, an irradiance of ultraviolet ray with respect to the object S can be increased.

The irradiation device 100 is not limited to the configuration in which the ray distribution angles are made different from each other between the first ray source 11 and the second ray source 12. For example, the ray distributions of the first ray source 11 and the second ray source 12 may be made different from each other by making directions of the optical axes of emitted ultraviolet rays different from each other between the first ray source 11 and the second ray source 12. This will be described specifically with reference to FIGS. 4 and 5. In FIGS. 4 and 5, the first ray source 11 emits the first ultraviolet ray U1 whose optical axis travels in a first direction D1 as the first optical axis C1. The second ray source 12 emits the second ultraviolet ray U2 whose optical axis travels in a second direction D2 as the second optical axis C2 different from the first direction D1. The object S has the first surface S1 and the second surface S2 that is continuous from the first surface S1 and is not parallel to the first surface S1. The first surface S1 is irradiated with the ray having the peak ray irradiance of the first ultraviolet ray U1 from the first ray source 11, and the second surface S2 is irradiated with the ray having the peak ray irradiance of the second ultraviolet ray U2 from the second ray source 12.

As illustrated in FIG. 4, the first surface S1 is irradiated with both of the first ultraviolet ray U1 and the second ultraviolet ray U2. In contrast, the second surface S2 is not substantially irradiated with the first ultraviolet ray U1 and is irradiated with the second ultraviolet ray U2 having the second optical axis C2 inclined with respect to the first optical axis C1 of the first ultraviolet ray U1. That is, as illustrated in FIG. 5, the second surface S2 is mainly irradiated with the second ultraviolet ray U2. Because the second surface S2 is irradiated with the second ultraviolet ray U2, the second surface S2 can be irradiated with the ultraviolet ray even when the object S includes the second surface S2. Accordingly, the uneven curing of the object S can be reduced.

In the example illustrated in FIGS. 4 and 5, the second ray source 12 includes a second ray-emitting element 121 and a second lens 122 disposed between the second ray-emitting element 121 and the object S. The second lens 122 changes the direction of the optical axis of ultraviolet ray emitted from the second ray-emitting element 121. The second lens 122 changes the direction of the optical axis of the ultraviolet ray emitted from the second ray-emitting element 121, and thus, as a result, the optical axis of the second ultraviolet ray U2 emitted from the second ray source 12 becomes the second optical axis C2 inclined with respect to the first optical axis C1. The second lens 122 can make the second direction D2 in which the second ultraviolet ray U2 is emitted from the second ray source 12 different from the first direction D1 in which the first ultraviolet ray U1 is emitted from the first ray source 11, and the object S can be irradiated with the ultraviolet rays in which the directions of rays having peak ray intensities are different from each other. The optical axis of the second ultraviolet ray U2 emitted from the second ray source 12 may be set to the second optical axis C2 inclined with respect to the first optical axis C1 by mounting the second ray-emitting element 121 so as to incline with respect to the first ray-emitting element without providing the second lens 122.

Meanwhile, from another viewpoint, the ray-emitting device 1 included in the irradiation device 100 is a ray-emitting device mounted in the irradiation device 100 that irradiates the object S with ray. The ray-emitting device 1 includes the first ray source 11 and the second ray source 12 that emit the ultraviolet rays having mutually different ray distributions. At least a non-overlapping region is present in the region irradiated with ray from the first ray source 11 and the region irradiated with ray from the second ray source 12. For example, the second region Ar2 and the second surface S2 in FIGS. 1 to 3 are regions that are not irradiated with ray from the first ray source 11 and are irradiated with ray from the second ray source 12, and thus correspond to “at least a non-overlapping region”.

In the ray-emitting device 1, the region irradiated with the ray from the first ray source 11 and the region irradiated with the ray from the second ray source 12 are different from each other, and thus the above-described “at least a non-overlapping region” is generated. As a result, the first surface S1 and the second surface S2 can be appropriately irradiated with the ultraviolet ray from at least one of the first ray source 11 and the second ray source 12. As a result, in the present embodiment, a region in which curing is insufficient can be reduced, and the uneven curing of the object S can be reduced.

In the ray-emitting device 1, the first ray source 11 emits the ultraviolet ray at the first ray distribution angle ϕ1, and the second ray source 12 emits the ultraviolet ray at the second ray distribution angle ϕ2 different from the first ray distribution angle ϕ1. Accordingly, the ray-emitting device 1 can irradiate the object S with the ultraviolet rays having mutually different ray distributions.

As illustrated in FIG. 6, the object S includes a base body T and a coating material P applied to a surface of the base body T. The base body T illustrated in FIG. 6 is a bowl-shaped material including a recessed portion TO. However, the shape and material of the base body T are not particularly limited. The thickness of the coating material P is, for example, in a range from 5 μm to 300 μm. The coating material P in the object S is cured by being irradiated with the ultraviolet ray from the irradiation device 100. From another viewpoint, the curing of the object S is the curing of the coating material P. However, a material to be applied to the object S is not limited to the coating material P, and may be a material other than the coating material P, such as ink, an adhesive, or a coating agent, as long as the material is cured by being irradiated with the ultraviolet ray U.

In the example illustrated in FIG. 1, the object S is conveyed by a conveying mechanism such as a conveyor in a moving direction A indicated by an arrow. The irradiation device 100 can irradiate the object S conveyed in the moving direction A with the first ultraviolet ray U1 and the second ultraviolet ray U2 from above. However, the irradiation device 100 is not limited to a device that irradiates the conveyed object S with the first ultraviolet ray U1 and the second ultraviolet ray U2, and may be a device that irradiates a standstill object S with the first ultraviolet ray U1 and the second ultraviolet ray U2. The irradiation device 100 may be a device that irradiates the object S with the second ultraviolet ray U2 after irradiating the object S with the first ultraviolet ray U1. Alternatively, the irradiation device 100 may be a device that moves the ray-emitting device 1 to the standstill or conveyed object S and irradiates the object S with the first ultraviolet ray U1 and the second ultraviolet ray U2. Furthermore, the irradiation of the first ultraviolet ray U1 and the second ultraviolet ray U2 by the irradiation device 100 is not limited to irradiation of the upper surface of the object S from above, and may be irradiation of the lower surface of the object S from below, or may be irradiation of the lateral surface of the object S from the side.

Each of the first ray source 11 and the second ray source 12 includes a ray-emitting element, and, for example, a ray-emitting diode (LED) can be used as the ray-emitting element. The ray-emitting elements may each include one or more ray-emitting diodes. When the ray-emitting element includes a plurality of ray-emitting diodes, the ray-emitting diodes are preferably formed of the same material. Each of the first ray source 11 and the second ray source 12 includes the ray-emitting diode, and thus heat generation of the irradiation device 100 can be reduced.

The placement table 2 to be used may be of any applicable type as long as the placement table 2 includes an arrangement region 20 which is a region where the object S is disposed in order to irradiate the object S with the ultraviolet ray.

The irradiation controller 3 has a physical and/or electrical mechanism for irradiating the object S with the ultraviolet ray from the first ray source 11 prior to the ultraviolet ray from the second ray source 12. The irradiation controller 3 may employ, for example, any of the following irradiation mechanisms (1) to (4).
(1) Irradiation mechanism that causes the object S to move with use of a conveying mechanism such as a conveyor.
(2) Irradiation mechanism that causes the ray-emitting device 1 to move with use of an actuator or the like.
(3) Irradiation mechanism that causes irradiation in order with respect to the object S, which is set still, with execution of a program stored in a nonvolatile memory such as a read only memory (ROM) by a central processing unit (CPU), or with control of an irradiation order by an electric circuit, an electronic circuit, or the like.
(4) Irradiation mechanism that controls one or more switches that can individually turn on or off the first ray source 11 and the second ray source 12. In the case of (4), an operator such as a user of the irradiation device 100 may also perform the switching.

The irradiation controller 3 illustrated in FIG. 1 controls the irradiance of each of the first ray source 11 and the second ray source 12 by controlling a current value of a drive current supplied to each of the ray-emitting elements included in the first ray source 11 and second ray source 12. In addition, the irradiation controller 3 controls the irradiation time of each of the first ray source 11 and the second ray source 12 by controlling timing of supply or supply stop of the drive current to each of the first ray source 11 and the second ray source 12. Furthermore, the irradiation controller 3 controls the irradiation time and the irradiation timing to the object S by each of the first ray source 11 and the second ray source 12 by causing the object S to relatively move with respect to the ray-emitting device 1.

### Second Embodiment

Next, an irradiation device according to a second embodiment will be described. The same names and reference characters as those in the previously described embodiment indicate the same or similar members or configurations, and detailed descriptions thereof are omitted as appropriate. This shall apply to the embodiments which will be described hereinafter.

### <Configuration of Irradiation Device According to Second Embodiment>

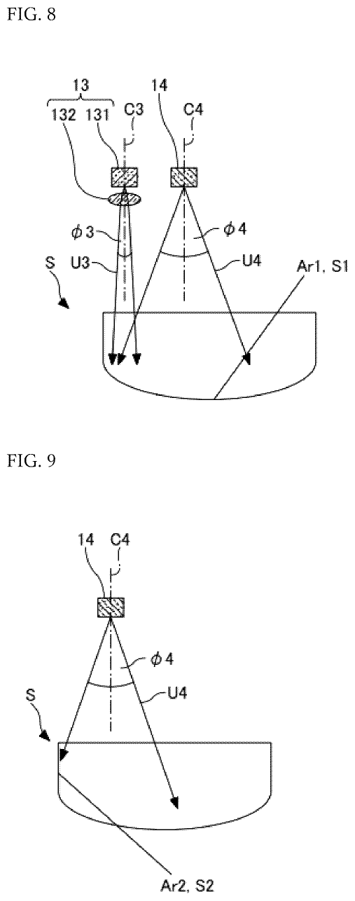

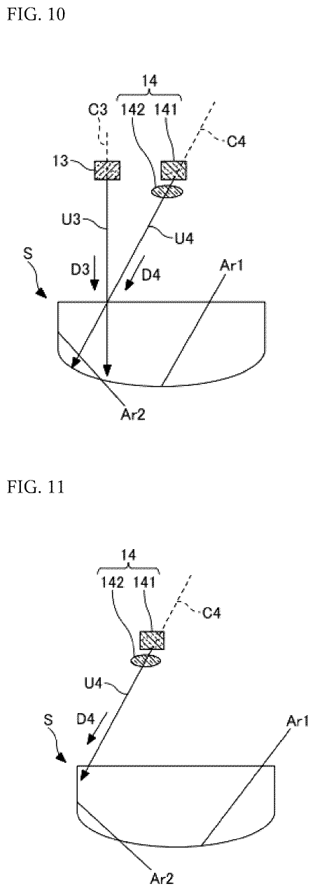

The configuration of an irradiation device according to a second embodiment will be described with reference to FIGS. 7 to 11. FIG. 7 schematically illustrates a side view of an irradiation device 100a according to the second embodiment. FIG. 8 schematically illustrates a cross-sectional view of the object S in a state in which the first region Ar1 of the object S is irradiated with both of third ultraviolet ray U3 from a third ray source 13 having a third ray distribution angle ϕ3 and fourth ultraviolet ray U4 from a fourth ray source 14 having a fourth ray distribution angle ϕ4. FIG. 9 schematically illustrates a cross-sectional view of the object S in a state in which a second region Ar2 of the object S is irradiated with the fourth ultraviolet ray U4 from the fourth ray source 14 having the fourth ray distribution angle ϕ4 but not substantially with the third ultraviolet ray U3. FIG. 10 schematically illustrates a cross-sectional view of the object S in a state in which the first surface S1 of the object S is irradiated with ray having a peak ray irradiance of the third ultraviolet ray U3 from the third ray source 13. FIG. 11 schematically illustrates a cross-sectional view of the object S in a state in which the second surface S2 of the object S is irradiated with ray having a peak ray irradiance of the fourth ultraviolet ray U4 from the fourth ray source 14.

In FIGS. 7 to 11, a part of each of the first ultraviolet ray U1, the second ultraviolet ray U2, the third ultraviolet ray U3, and the fourth ultraviolet ray U4 emitted from the irradiation device 100a is indicated by arrows. It is noted that the arrows indicating the first ultraviolet ray U1, the second ultraviolet ray U2, the third ultraviolet ray U3, and the fourth ultraviolet ray U4 mean that the irradiation device 100a can emit each of the first ultraviolet ray U1, the second ultraviolet ray U2, the third ultraviolet ray U3, and the fourth ultraviolet ray U4. Thus, the arrows indicating the first ultraviolet ray U1, the second ultraviolet ray U2, the third ultraviolet ray U3, and the fourth ultraviolet ray U4 do not mean that the irradiation device 100a is limitedly used for simultaneously emitting the first ultraviolet ray U1, the second ultraviolet ray U2, the third ultraviolet ray U3, and the fourth ultraviolet ray U4.

In the irradiation device 100a, the first ray source 11 and the second ray source 12 emit ultraviolet ray having a first ray emission peak wavelength. The irradiation device 100a further includes the third ray source 13 and the fourth ray source 14 that emit ultraviolet ray having a second ray emission peak wavelength different from the first ray emission peak wavelength. The difference between the first ray emission peak wavelength and the second ray emission peak wavelength is in a range from 70 nm to 150 nm, for example. The third ray source 13 emits the ultraviolet ray at the third ray distribution angle ϕ3. The fourth ray source 14 emits the ultraviolet ray at the fourth ray distribution angle ϕ4 larger than the third ray distribution angle ϕ3. The object S includes the first region Ar1 irradiated with both of ray from the third ray source 13 and ray from the fourth ray source 14, and the second region Ar2 irradiated with ray from the fourth ray source 14 but not substantially with the ray from the third ray source 13. The irradiation controller 3 irradiates the object S with the ultraviolet ray having the first ray emission peak wavelength prior to the ultraviolet ray having the second ray emission peak wavelength.

In the example illustrated in FIG. 7, the third ray source 13 and the fourth ray source 14 are disposed inside a housing 10B. Alternatively, the third ray source 13 and the fourth ray source 14 may be disposed on a surface of the housing 10B. The third ray source 13 irradiates the object S located below the housing 10B with the third ultraviolet ray U3. The fourth ray source 14 irradiates the object S located below the housing 10B with the fourth ultraviolet ray U4.

For example, in a case in which the object S is cured by being irradiated with a plurality of ultraviolet rays having different ray emission peak wavelengths, the absorption of the ultraviolet ray corresponding to the depth inside the object S from the surface of the object S on the side where the ray-emitting device 1 is located varies depending on the ray emission peak wavelength, and thus uneven curing may occur. Specifically, when ultraviolet ray having a ray emission peak wavelength that is absorbed inside the object S and thus is unlikely to reach a deep position is emitted first, only a shallow position inside the object S is cured. When the shallow position inside the object S is cured, even if ultraviolet ray having a ray emission peak wavelength that can reach a deep position inside the object S is emitted thereafter, the ultraviolet ray is prevented from proceeding by the cured region at the shallow position inside the object S, and thus the ultraviolet ray cannot reach the deep position. Accordingly, the deep position inside the object S cannot be cured. As a result, the shallow position inside the object S is cured, and curing at the deep position is insufficient. Meanwhile, when only ultraviolet ray having a ray emission peak wavelength that can reach the deep position inside the object S is emitted, curing proceeds at the deep position of the object S, but curing at the shallow position is insufficient. Thus, in a case in which the ultraviolet rays having mutually different ray emission peak wavelengths are not emitted, the uneven curing of the object S may occur.

The irradiation device 100a irradiates the object S with the first ultraviolet ray U1 and the second ultraviolet ray U2 having the first ray emission peak wavelength that can reach the deep position of the object S substantially without being absorbed, prior to the third ultraviolet ray U3 and the fourth ultraviolet ray U4 having the second ray emission peak wavelength. Accordingly, the deep position of the object S can be cured prior to the shallow position of the object S. After the deep position is cured, the object S is irradiated with the third ultraviolet ray U3 and the fourth ultraviolet ray U4 having the second ray emission peak wavelength, and thus the shallow position of the object S can be cured. Here, in a case in which the object S includes the base body T and the coating material P applied to the surface of the base body T, the shallow position is, for example, a region from the surface of the coating material P to a predetermined distance, and the deep position is a region of the coating material P farther than the predetermined distance. The predetermined distance is, for example, in a range from 45 μm to 75 μm. When the thickness of the coating material P is smaller than the predetermined distance, the entire region of the coating material P can be regarded as the shallow position. As described above, the object S can be suitably cured from the deep position to the surface by appropriately combining and using the first ultraviolet ray U1 and the second ultraviolet ray U2 having the first ray emission peak wavelength and the third ultraviolet ray U3 and the fourth ultraviolet ray U4 having the second ray emission peak wavelength, and the uneven curing of the object S can be reduced.

In the example illustrated in FIG. 7, the first ray emission peak wavelength is in a range from 360 nm to 410 nm. The second ray emission peak wavelength is in a range from 260 nm to 290 nm. When the first ray emission peak wavelength is set in a range from 360 nm to 410 nm, the ray having the first ray emission peak wavelength can reach the deep position inside the object S substantially without being absorbed, and the deep position can be cured. When the second ray emission peak wavelength is set in a range from 260 nm to 290 nm, the shallow position inside the object S can be cured. As described above, the object S can be suitably cured from the deep position to the surface, and the uneven curing of the object S can be reduced.

The object S is relatively moved with respect to the irradiation device in the moving direction A. The first ray source 11 and the second ray source 12 are disposed upstream the third ray source 13 and the fourth ray source 14 in the moving direction A. When the object S is relatively moved with respect to the irradiation device, the same position on the object S can be irradiated with the ultraviolet ray having the first ray emission peak wavelength from the first ray source 11 and the second ray source 12 and the ultraviolet ray having the second ray emission peak wavelength from the third ray source 13 and the fourth ray source 14. When the object S is irradiated with the ultraviolet ray having the first ray emission peak wavelength prior to the ultraviolet ray having the second ray emission peak wavelength, the object S can be suitably cured from the deep position to the surface, and the uneven curing of the object S can be reduced.

In the irradiation device 100a, in the moving direction A, a distance d2 between the second ray source 12 and the third ray source 13 is larger than a distance d1 between the first ray source 11 and the second ray source 12. Accordingly, interference between the second ray source 12 and the third ray source 13 can be avoided. That is, the possibility that the object S is irradiated with the ray from the third ray source 13 prior to the ray from the second ray source 12 can be reduced.

The third ray source 13 emits the third ultraviolet ray U3 at the third ray distribution angle ϕ3. The fourth ray source 14 emits the fourth ultraviolet ray U4 at the fourth ray distribution angle ϕ4 larger than the third ray distribution angle ϕ3. The object S includes the first region Ar1 irradiated with both of the third ultraviolet ray U3 from the third ray source 13 and the fourth ultraviolet ray U4 from the fourth ray source 14, and the second region Ar2 irradiated with the fourth ultraviolet ray U4 from the fourth ray source 14 but not substantially with the third ultraviolet ray U3 from the third ray source 13.

In FIGS. 8 and 9, the first region Ar1 is a region facing the third ray source 13 and the fourth ray source 14 and including the first surface S1 intersecting each of a third optical axis C3 of the third ultraviolet ray U3 and a fourth optical axis C4 of the fourth ultraviolet ray U4. In FIG. 9, the second region Ar2 is a region including the second surface S2 substantially parallel to each of the third optical axis C3 of the third ultraviolet ray U3 and the fourth optical axis C4 of the fourth ultraviolet ray U4.

As illustrated in FIG. 8, the first region Ar1 is irradiated with both of the third ultraviolet ray U3 and the fourth ultraviolet ray U4. In contrast, the second region Ar2 is hardly irradiated with the third ultraviolet ray U3 having a small ray distribution angle, and is irradiated with the fourth ultraviolet ray U4 having a larger ray distribution angle than the third ultraviolet ray U3. That is, as illustrated in FIG. 9, the second region Ar2 is mainly irradiated with the fourth ultraviolet ray U4. Because the second region Ar2 is irradiated with the fourth ultraviolet ray U4, the second region Ar2 can be irradiated with the ultraviolet ray even when the object S includes the second region Ar2, and the uneven curing of the object S can be reduced.

The third ray source 13 includes a third ray-emitting element 131 and a third lens 132 disposed between the third ray-emitting element 131 and the object S. The third lens 132 changes the ray distribution angle of ultraviolet ray emitted from the third ray-emitting element 131. The third lens 132 can make the third ray distribution angle ϕ3 of the third ultraviolet ray U3 emitted from the third ray source 13 different from the fourth ray distribution angle ϕ4 of the fourth ultraviolet ray U4 emitted from the fourth ray source 14. Accordingly, the object S can be irradiated with the ultraviolet rays having mutually different ray distributions.

In the irradiation device 100a illustrated in FIG. 7, each of the first ray distribution angle ϕ1 and the third ray distribution angle ϕ3 is in a range from 30 degrees to 70 degrees. Each of the second ray distribution angle ϕ2 and the fourth ray distribution angle ϕ4 is in a range from 110 degrees to 130 degrees. When these conditions are satisfied, in the irradiation device 100a, the second region Ar2 can be irradiated with the ultraviolet ray even if the object S includes the second region Ar2. Accordingly, the uneven curing of the object S can be reduced.

The irradiation device 100a is not limited to the configuration in which the ray distribution angles are different between the third ray source 13 and the fourth ray source 14. For example, the directions of the optical axes of the emitted ultraviolet rays may be different between the third ray source 13 and the fourth ray source 14. This will be described specifically with reference to FIGS. 10 and 11. In FIGS. 10 and 11, in the irradiation device 100a, the third ray source 13 emits ultraviolet ray whose optical axis travels in a third direction D3. The fourth ray source 14 emits ultraviolet ray whose optical axis travels in a fourth direction D4 as an optical axis different from the third direction D3. The object S includes the first region Ar1 irradiated with both of ray from the third ray source 13 and ray from the fourth ray source 14, and the second region Ar2 irradiated with ray from the fourth ray source 14 but not substantially with ray from the third ray source 13.

As illustrated in FIG. 10, the first region Ar1 is irradiated with both of the third ultraviolet ray U3 and the fourth ultraviolet ray U4. In contrast, the second region Ar2 is hardly irradiated with the third ultraviolet ray U3 and is irradiated with the fourth ultraviolet ray U4 having the fourth optical axis C4 inclined with respect to the third optical axis C3 of the third ultraviolet ray U3. That is, as illustrated in FIG. 11, the second region Ar2 is mainly irradiated with the fourth ultraviolet ray U4. Because the second region Ar2 is irradiated with the fourth ultraviolet ray U4, the second region Ar2 can be irradiated with the ultraviolet ray even when the object S includes the second region Ar2. Accordingly, the uneven curing of the object S can be reduced.

The fourth ray source 14 includes a fourth ray-emitting element 141 and a fourth lens 142 disposed between the fourth ray-emitting element 141 and the object S. The fourth lens 142 changes the ray distribution angle of ultraviolet ray emitted from the fourth ray-emitting element 141. The fourth lens 142 changes the direction of the optical axis of the ultraviolet ray emitted from the fourth emitted ray-emitting element 141, and thus, as a result, the optical axis of the fourth ultraviolet ray U4 emitted from the fourth ray source 14 becomes the fourth optical axis C4 inclined with respect to the third optical axis C3. The fourth lens 142 can make the fourth ray distribution angle ϕ4 of the fourth ultraviolet ray U4 emitted from the fourth ray source 14 different from the third ray distribution angle ϕ3 of the third ultraviolet ray U3 emitted from the third ray source 13, and the object S can be irradiated with the ultraviolet rays having mutually different ray distributions. The optical axis of the fourth ultraviolet ray U4 emitted from the fourth ray source 14 may be set to the fourth optical axis C4 inclined with respect to the third optical axis C3 by mounting the fourth ray-emitting element 141 in an inclined manner without providing the fourth lens 142.

Each of the third ray source 13 and the fourth ray source 14 includes a ray-emitting element, and, for example, a ray-emitting diode can be used as the ray-emitting element. The ray-emitting elements may each include one or more ray-emitting diodes. When the ray-emitting element includes a plurality of ray-emitting diodes, the ray-emitting diodes are preferably formed of the same material. Each of the third ray source 13 and the fourth ray source 14 includes the ray-emitting diode, and thus the size of the irradiation device 100a can be reduced.

Meanwhile, from another viewpoint, the ray-emitting device 1a further includes the third ray source 13 that emits ultraviolet ray and the fourth ray source 14 that emits ultraviolet ray having a ray distribution different from a ray distribution of the ultraviolet ray emitted from the third ray source 13. The first ray source 11 and the second ray source 12 emit the ultraviolet ray having the first ray emission peak wavelength. The third ray source 13 and the fourth ray source 14 emit the ultraviolet ray having the second ray emission peak wavelength different from the first ray emission peak wavelength. The third ray source 13 emits the ultraviolet ray at the third ray distribution angle ϕ3. The fourth ray source 14 emits the ultraviolet ray at the fourth ray distribution angle ϕ4 larger than the third ray distribution angle ϕ3. The object S includes the first region Ar1 irradiated with both of ray from the third ray source 13 and ray from the fourth ray source 14, and the second region Ar2 irradiated with ray from the fourth ray source 14 but not substantially with ray from the third ray source 13.

In the ray-emitting device 1a, the second surface S2 can be appropriately irradiated with the ultraviolet ray from at least one of the first ray source 11 and the second ray source 12 even when the object S includes the second surface S2 substantially parallel to the first optical axis C1. As a result, in the ray-emitting device 1a, a region in which curing is insufficient can be reduced, and the uneven curing of the object S can be reduced.

### <Ultraviolet Ray Irradiation Method Using Irradiation Device 100a According to Second Embodiment>

The irradiation device 100a emits the ultraviolet rays having mutually different ray distributions and having the first ray emission peak wavelength from the first ray source 11 and the second ray source 12, and emits the ultraviolet ray having mutually different ray distributions and having the second ray emission peak wavelength from the third ray source 13 and the fourth ray source 14. The second ray emission peak wavelength is shorter than the first ray emission peak wavelength. Further, the irradiation device 100a irradiates the object S with the ultraviolet ray having the first ray emission peak wavelength prior to the ultraviolet ray having the second ray emission peak wavelength.

Specifically, the irradiation device 100a emits the first ultraviolet ray U1 having the first ray emission peak wavelength at the first ray distribution angle ϕ1 from the first ray source 11. The irradiation device 100a emits the second ultraviolet ray U2 having the first ray emission peak wavelength at the second ray distribution angle ϕ2 different from the first ray distribution angle ϕ1 from the second ray source 12. The irradiation device 100a emits the third ultraviolet ray U3 having the second ray emission peak wavelength at the third ray distribution angle ϕ3 from the third ray source 13. The irradiation device 100a emits the fourth ultraviolet ray U4 having the second ray emission peak wavelength at the fourth ray distribution angle ϕ4 different from the third ray distribution angle ϕ3 from the fourth ray source 14. The irradiation device 100a irradiates the object S with the first ultraviolet ray U1 and the second ultraviolet ray U2 prior to the third ultraviolet ray U3 and the fourth ultraviolet ray U4. As described above, in the ultraviolet ray irradiation method according to the present embodiment, the object S can be suitably cured from the deep position to the surface, and the uneven curing of the object S can be reduced.

In addition, the irradiation device 100a irradiates the object S relatively moving in the moving direction A with the ultraviolet ray, and the first ray source 11 and the second ray source 12 are disposed upstream the third ray source 13 and the fourth ray source 14 in the moving direction A. Accordingly, the object S can be irradiated with the first ultraviolet ray U1 and the second ultraviolet ray U2 having the first ray emission peak wavelength from the first ray source 11 and the second ray source 12, prior to the third ultraviolet ray U3 and the fourth ultraviolet ray U4 having the second ray emission peak wavelength from the third ray source 13 and the fourth ray source 14. As a result, in the irradiation device 100a, the object S can be suitably cured from the deep position to the surface, and the uneven curing of the object S can be reduced.

### Third Embodiment

An irradiation device according to a third embodiment will be described.

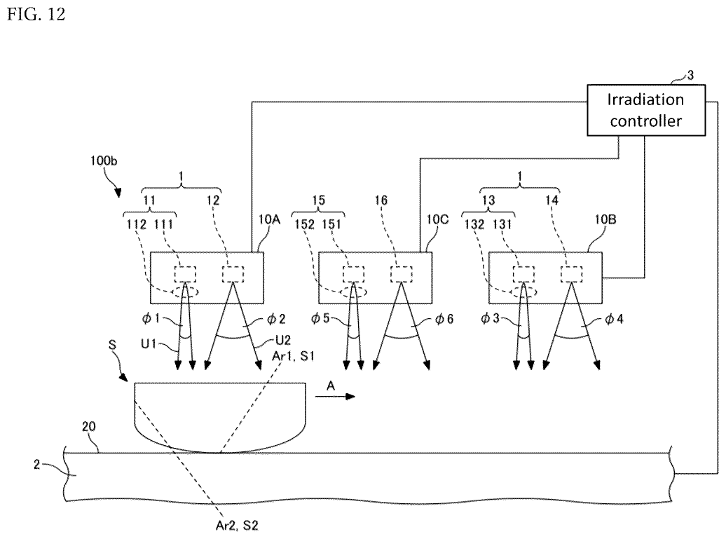

FIG. 12 schematically illustrates a side view of an irradiation device 100b according to the third embodiment. In FIG. 12, a part of each of first ultraviolet ray U1, second ultraviolet ray U2, third ultraviolet ray U3, fourth ultraviolet ray U4, fifth ultraviolet ray U5, and sixth ultraviolet ray U6 emitted from the irradiation device 100b is indicated by arrows. It is noted that the arrows indicating the first ultraviolet ray U1, the second ultraviolet ray U2, the third ultraviolet ray U3, the fourth ultraviolet ray U4, the fifth ultraviolet ray U5, and the sixth ultraviolet ray U6 mean that the irradiation device 100b can emit each of the first ultraviolet ray U1, the second ultraviolet ray U2, the third ultraviolet ray U3, the fourth ultraviolet ray U4, the fifth ultraviolet ray U5, and the sixth ultraviolet ray U6. Thus, the arrows indicating the first ultraviolet ray U1, the second ultraviolet ray U2, the third ultraviolet ray U3, the fourth ultraviolet ray U4, the fifth ultraviolet ray U5, and the sixth ultraviolet ray U6 do not mean that the irradiation device 100b is limitedly used for simultaneously emitting the first ultraviolet ray U1, the second ultraviolet ray U2, the third ultraviolet ray U3, the fourth ultraviolet ray U4, the fifth ultraviolet ray U5, and the sixth ultraviolet ray U6.

The irradiation device 100b includes the fifth ray source 15 and the sixth ray source 16 that emit ultraviolet rays having mutually different ray distributions and having a third ray emission peak wavelength different from both of the first ray emission peak wavelength and the second ray emission peak wavelength. The fifth ray source 15 and the sixth ray source 16 are disposed between a following (i) and (ii) in the moving direction A, (i) constituting of the first and second ray sources 11, 12, and (ii) constituting of the third and fourth ray sources 13, 14. The third ray emission peak wavelength is shorter than the first ray emission peak wavelength and longer than the second ray emission peak wavelength.

In the example illustrated in FIG. 12, the fifth ray source 15 and the sixth ray source 16 are disposed inside a housing 10C. The fifth ray source 15 irradiates the object S located below the housing 10C with the fifth ultraviolet ray U5. The sixth ray source 16 irradiates the object S located below the housing 10C with the sixth ultraviolet ray U6.

In the irradiation device 100b, the first ultraviolet ray U1 and the second ultraviolet ray U2 having the first ray emission peak wavelength that can reach the deep position of the object S substantially without being absorbed are emitted. Subsequently, the fifth ultraviolet ray U5 and the sixth ultraviolet ray U6 are emitted which have the third ray emission peak wavelength that can reach the deep position of the object S substantially without being absorbed. The third ray emission peak wavelength can reach deeper position of the subject S as compared with the ultraviolet ray having the second ray emission peak wavelength. Further subsequently, the third ultraviolet ray U3 and the fourth ultraviolet ray U4 having the second ray emission peak wavelength are emitted. Because the third ray emission peak wavelength is shorter than the first ray emission peak wavelength and longer than the second ray emission peak wavelength, the ray having the third ray emission peak wavelength can suitably cure a region in the depth direction inside the object S between the region cured by the ultraviolet ray having the first ray emission peak wavelength and the region cured by the ultraviolet ray having the second ray emission peak wavelength. The object S can be regarded as including the region cured by the ultraviolet ray having the first ray emission peak wavelength, the region cured by the ultraviolet ray having the third ray emission peak wavelength, and the region cured by the ultraviolet ray having the second ray emission peak wavelength. Here, when the object S includes the base body T and the coating material P applied to the surface of the base body T, the region cured by the ultraviolet ray having the first ray emission peak wavelength is, for example, a region from the surface of the coating material P farther than a predetermined first distance, and the region cured by the ultraviolet ray having the second ray emission peak wavelength is, for example, a region to a predetermined second distance from the surface of the coating material P. The region between the region cured by the ultraviolet ray having the first ray emission peak wavelength and the region cured by the ultraviolet ray having the second ray emission peak wavelength is, for example, a region to the predetermined first distance from the surface of the coating material P and a region from the surface of the coating material P farther than the predetermined second distance. The predetermined first distance is, for example, in a range from 90 μm to 135 μm. The predetermined second distance is, for example, in a range from 45 μm to 75 μm. When the thickness of the coating material P is smaller than the predetermined second distance, the entire region of the coating material P can be regarded as the region cured by the ultraviolet ray having the second ray emission peak wavelength. When the thickness of the coating material P is smaller than the predetermined first distance and larger than the predetermined second distance, the coating material P can be regarded as including the region cured by the ultraviolet ray having the second ray emission peak wavelength and the region cured by the ultraviolet ray having the third ray emission peak wavelength. As described above, the fifth ultraviolet ray U5 and the sixth ultraviolet ray U6 are present, and thus the uncured region can be reduced, and the object S can be efficiently cured. As a result, the uneven curing of the object S in the depth direction can be reduced.

In the example illustrated in FIG. 12, the third ray emission peak wavelength is in a range from 300 nm to 350 nm. Accordingly, the region in the depth direction inside the object S between the region cured by the ultraviolet ray having the first ray emission peak wavelength and the region cured by the ultraviolet ray having the second ray emission peak wavelength can be suitably cured.

The fifth ray source 15 includes a fifth ray-emitting element 151 and a fifth lens 152 disposed between the fifth ray-emitting element 151 and the object S. The fifth lens 152 changes the ray distribution angle of the ultraviolet ray emitted from the fifth ray-emitting element 151. The fifth lens 152 can make a fifth ray distribution angle ϕ5 of the fifth ultraviolet ray U5 emitted from the fifth ray source 15 different from a sixth ray distribution angle ϕ6 of the sixth ultraviolet ray U6 emitted from the sixth ray source 16, and the object S can be irradiated with the ultraviolet rays having mutually different ray distributions.

While preferred embodiments have been described in detail above, the disclosure is not limited to the above-described embodiments, and various modifications and substitutions can be made to the above-described embodiments as long as they do not depart from the scope described in the claims.

The ordinal numbers, quantity, and the like used in the description of the embodiments all are exemplified to specifically describe the technique of the present disclosure, and the present disclosure is not limited to the numbers exemplified. In addition, the connection relationship between the components is exemplified for specifically describing the technique of the present disclosure, and the connection relationship for achieving the function of the present disclosure is not limited thereto.

The ultraviolet ray irradiation method of the present disclosure can reduce the uneven curing of the object, and thus it can be suitably used for curing the object in applications such as coating, material coating, printing, and exposure in which the object is irradiated with ultraviolet ray. From the viewpoint of efficiently curing an object having a thickness of 10 μm or more, the method is particularly suitable for coating application of vehicles such as automobiles. However, the ultraviolet ray irradiation method of the present disclosure is not limited to these applications.

What is claimed is:

1. An irradiation device configured to irradiate an object with ray, the irradiation device comprising:
a ray-emitting device comprising a first ray source configured to emit first ultraviolet ray and a second ray source configured to emit second ultraviolet ray having a ray distribution different from a ray distribution of the first ultraviolet ray emitted from the first ray source;
a placement table comprising an arrangement region on which the object is disposed for irradiation; and
an irradiation controller configured to cause the object to be irradiated with the first ultraviolet ray prior to the second ultraviolet ray.

2. The irradiation device according to claim 1, wherein
the first ultraviolet ray has a first ray distribution angle,
the second ultraviolet ray has a second ray distribution angle larger than the first ray distribution angle.

3. The irradiation device according to claim 2, wherein
the first ray source comprises
a first ray-emitting element, and
a first lens disposed between the first ray-emitting element and the placement table.

4. The irradiation device according to claim 2, wherein
each of the first ultraviolet ray and the second ultraviolet ray has a first ray emission peak wavelength,
the irradiation device further comprises a third ray source configured to emit third ultraviolet ray having a second ray emission peak wavelength different from the first ray emission peak wavelength and having a third ray distribution angle, and a fourth ray source configured to emit fourth ultraviolet ray having the second ray emission peak wavelength and having a fourth ray distribution angle larger than the third ray distribution angle, and
the irradiation controller is configured to cause the object to be irradiated with the first and second ultraviolet rays prior to the third and fourth ultraviolet rays.

5. The irradiation device according to claim 4, wherein
each of the first ray distribution angle and the third ray distribution angle is in a range from 30 degrees to 70 degrees, and
each of the second ray distribution angle and the fourth ray distribution angle is in a range from 110 degrees to 130 degrees.

6. The irradiation device according to claim 4, wherein
the first ray emission peak wavelength is in a range from 360 nm to 410 nm, and
the second ray emission peak wavelength is in a range from 260 nm to 290 nm.

7. The irradiation device according to claim 4, wherein
the irradiation controller is configured to cause the object to relatively move with respect to the irradiation device in a moving direction, and
a group of the first ray source and the second ray source is disposed upstream a group of the third ray source and the fourth ray source in the moving direction.

8. The irradiation device according to claim 7, wherein a distance between the second ray source and the third ray source is larger than a distance between the first ray source and the second ray source in the moving direction.

9. The irradiation device according to claim 7, wherein
the ray-emitting device further comprises a fifth ray source configured to emit fifth ultraviolet ray having a third ray emission peak wavelength different from the first ray emission peak wavelength and the second ray emission peak wavelength, and a sixth ray source configured to emit sixth ultraviolet ray having the third ray emission peak wavelength and having a ray distribution different from a ray distribution of the fifth ultraviolet ray from the fifth ray source, and
a group of the fifth ray source and the sixth ray source is disposed between a group of the first ray source and the second ray source and a group of the third ray source and the fourth ray source in the moving direction.

10. The irradiation device according to claim 9, wherein the third ray emission peak wavelength is in a range from 300 nm to 350 nm.

11. The irradiation device according to claim 2, wherein
each of the first ultraviolet ray and the second ultraviolet ray has a first ray emission peak wavelength,
the irradiation device further comprises a third ray source configured to emit third ultraviolet ray having a second ray emission peak wavelength different from the first ray emission peak wavelength and having a first optical axis, and a fourth ray source configured to emit fourth ultraviolet ray having the second ray emission peal wavelength and having a second optical axis inclined with respect to the first optical axis.

12. The irradiation device according to claim 1, wherein
the first ultraviolet ray emitted from the first ray source has a first optical axis,
the second ultraviolet ray emitted from the second ray source has a second optical axis inclined with respect to the first optical axis.

13. The irradiation device according to claim 12, wherein
the second ray source comprises
a second ray-emitting element, and
a second lens disposed between the second ray-emitting element and the placement table.

14. The irradiation device according to claim 1, wherein each of the first ray source and the second ray source comprises a ray-emitting diode.

15. A ray-emitting device mounted in an irradiation device configured to irradiate an object with ray, the ray-emitting device comprising:
a first ray source configured to emit first ultraviolet ray; and
a second ray source configured to emit second ultraviolet ray having a ray distribution different from a ray distribution of the first ultraviolet ray, wherein
in a region for irradiating the object, a non-overlapping region that is irradiated with one but not both of the first ultraviolet ray and the second ultraviolet ray is generated.

16. The ray-emitting device according to claim 15, wherein
the first ultraviolet ray has a first ray distribution angle, and
the second ultraviolet ray has a second ray distribution angle larger than the first ray distribution angle.

17. The ray-emitting device according to claim 16, further comprising:
a third ray source configured to emit third ultraviolet ray; and
a fourth ray source configured to emit fourth ultraviolet ray having a ray distribution different from a ray distribution of the third ultraviolet ray, wherein
each of the first ultraviolet ray and the second ultraviolet ray has a first ray emission peak wavelength,
each of the third ultraviolet ray and the fourth ultraviolet ray has a second ray emission peak wavelength different from the first ray emission peak wavelength,
the third ultraviolet ray has a third ray distribution angle,
the fourth ultraviolet ray has a fourth ray distribution angle larger than the third ray distribution angle.

18. An ultraviolet ray irradiation method, comprising:
irradiating an object with first ultraviolet ray from a first ray source, the first ultraviolet ray having a first ray emission peak wavelength;
irradiating the object with second ultraviolet ray from a second ray source, the second ultraviolet ray having the first ray emission peak wavelength and having a ray distribution different from a ray distribution of the first ultraviolet ray;
irradiating the object with third ultraviolet ray from a third ray source, the third ultraviolet ray having a second ray emission peak wavelength shorter than the first ray emission peak wavelength; and
irradiating the object with fourth ultraviolet ray from a fourth ray source, the fourth ultraviolet ray having the second ray emission peak wavelength and having a ray distribution different from a ray distribution of the third ultraviolet ray,
wherein said irradiating the object with the first ultraviolet ray and the second ultraviolet ray is performed prior to said irradiating the object with the third ultraviolet ray and the fourth ultraviolet ray.

19. The ultraviolet ray irradiation method according to claim 18, further comprising:
causing the object to relatively move with respect to the first, second, third, and fourth ray sources in a moving direction,
wherein a group of the first ray source and the second ray source is disposed upstream a group of the third ray source and the fourth ray source in the moving direction.
